(19) United States
(12) Patent Application Publication
(10) Pub. No.: US 2007/0080218 A1
(43) Pub. Date: Apr. 12, 2007

(54) Sale and warranty confirmation management

(75) Inventors: John Madsen, Santa Clara, CA (US); Edmund C. Taylor, Hillsborough, CA (US)

Correspondence Address: VAN PELT, YI & JAMES LLP, 10050 N. FOOTHILL BLVD #200, CUPERTINO, CA, 95014, US

(73) Assignee: Lussori Inc.

(21) Appl. No.: 11/246,912

(22) Filed: Oct. 6, 2005

(51) Int. Cl. G06K 15/00

(52) U.S. Cl. 235/383

(57) ABSTRACT

Sale and warranty confirmation management is disclosed. Product information is displayed for a buyer, and a selection of a desired product is received. A transaction for the desired product is completed, and a transaction confirmation record is stored, wherein the transaction confirmation record is auditable in order to confirm that the transaction for the desired product was completed with the buyer.

### BACKGROUND OF THE INVENTION

Retail luxury goods are sold by manufacturers through authorized distributors and retail locations. This allows the manufacturer to control the customer experience and also to ensure that the customer received their product. It is important for the manufacturer to know that their products were sold to an end customer so that the manufacturer knows that their products were handled and sold appropriately. In this situation, the manufacturer receives the full economic benefit from their product and can also provide better follow up service to their customers. Internet sales offer an alternate sales channel for manufacturers. However, the internet customer cannot generally be known in the same way as a customer in a retail location. It would be useful to be able to enable the manufacturer to be able to control the customer experience and to ensure that the customer receives their product through an appropriate channel, and to handle the customer relationship appropriately, given the channel through which the product was obtained by the customer.

### BRIEF DESCRIPTION OF THE DRAWINGS

Various embodiments of the invention are disclosed in the following detailed description and the accompanying drawings.

FIG. 1 is a block diagram illustrating an embodiment of entities involved in completing an authorized transaction for a product.

FIG. 2 is a flow diagram illustrating an embodiment of a process for completing an authorized transaction for a product.

FIG. 3 is a flow diagram illustrating an embodiment of a process for displaying product information.

FIG. 4 is a flow diagram illustrating an embodiment of a process for receiving a selection of a desired product.

FIG. 5 is a flow diagram illustrating a process for completing a transaction for a desired product.

FIG. 6 is a flow diagram illustrating an embodiment of storing transaction information including a transaction confirmation record.

FIG. 7 is a flow diagram illustrating an embodiment of checking transaction information including a transaction confirmation record.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links including wireless?. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Sale and warranty confirmation management is disclosed. Product information is displayed for a buyer. The buyer selects a desired product and completes an authorized transaction for the desired product. A transaction confirmation record is stored wherein the transaction confirmation record is auditable in order to confirm that the transaction for the desired product was completed with the buyer. In some embodiments, the transaction confirmation record includes warranty information in order to confirm warranty is authentic.

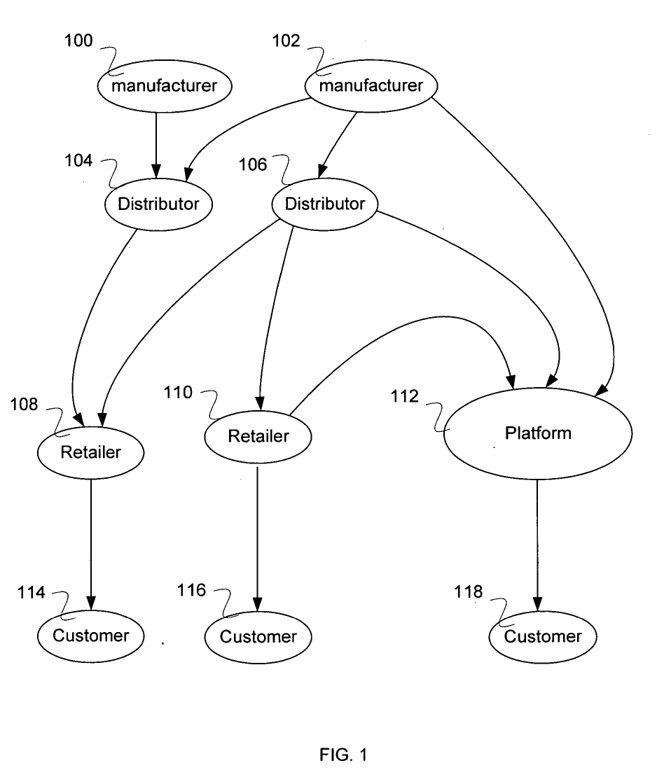

FIG. 1 is a block diagram illustrating an embodiment of entities involved in completing an authorized transaction for a product. In the example shown, a plurality of manufacturers represented in FIG. 1 by manufacturers 100 and 102 distribute products through a plurality of distributors represented in FIG. 1 by distributor 104 and 106. Distributors can be associated with geographic regions—for example, a North American or European distributor. Distributors are either independently owned or owned by the manufacturer. Distributors handle local tax, customs issues, warranty issues, legal, retailer interactions, customer service, product returns, and manufacturer interactions. Distributors sell product to a plurality of retailers represented in FIG. 1 by retailer 108 and 110. Retailers sell to a plurality of customers represented in FIG. 1 by customer 114 and 116. In various embodiments, there may be only a single distributor for a manufacturer, a single manufacturer for a distributor, or a single retailer for a distributor.

Manufacturers, distributors, and retailers also sell to platform 112. Platform 112 is an internet website. In various embodiments, platform 112 is an independent website, a dedicated retailer website, a dedicated manufacturer website, a portion or linked portion of a website, or any other appropriate website or web presence for selling products. Platform 112 sells to a plurality of customers represented in FIG. 1 by customer 118.

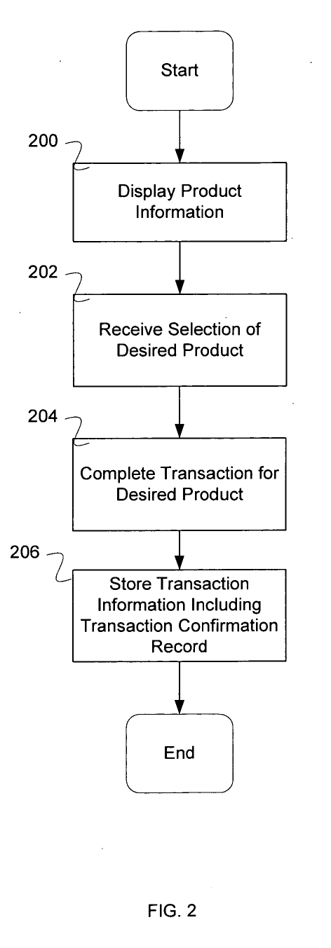

FIG. 2 is a flow diagram illustrating an embodiment of a process for completing an authorized transaction for a product. In the example shown, in 200 product information is displayed. Product information can include product image(s), description, specifications, options, pricing, availability, authenticity certificate, and/or serial number. In 202, a selection of a desired product is received. Selecting a product involve one or more modes of communication including clicking on a website, emailing, live chatting, messaging, phone calling, faxing, or any other appropriate communication mode for selecting or enabling a customer to select a desired product and/or options of the product. In some embodiments, the selection process involves consulting on the appropriate style, features, or options of the product with expert consultants available to help in the selection. In 204 a transaction for a desired product is completed. Completing a transaction can include checking for availability, verifying customer identity, receiving money, obtaining desired product, inspecting and testing desired product, customize desired product, prepare desired product, prepare warranty, and ship product. In various embodiments, completing the transaction involves using the Internet, communicating directly between the customer and the retailer, distributor, or manufacturer by phone, fax, email, messaging, in person, or any other appropriate manner for completing the transaction. In 206, transaction information is stored including a transaction confirmation record. Transaction information includes customer information, sales information, warranty information, shipping information, and/or any other information appropriate for an auditable authorized transaction record.

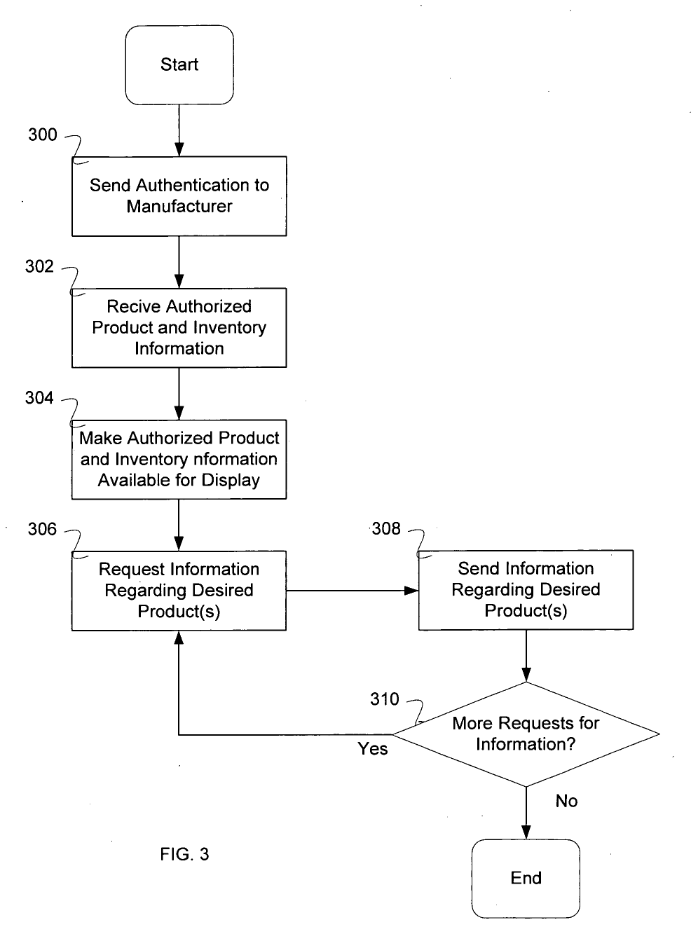

FIG. 3 is a flow diagram illustrating an embodiment of a process for displaying product information. In some embodiments, the process of FIG. 3 is used to implement 200 in FIG. 2. In the example shown, in 300 authentication is sent to the manufacturer. In 302, authorized product and inventory information is received from the manufacturer. In various embodiments, authorized product and/or inventory information is received on a periodic schedule, for every product inquiry at the website, or whenever appropriate as required by the website. In various embodiments, the product information is received as an electronic file, as hard copy or paper copy documents, or any other appropriate manner for receiving the product information. In some embodiments, authorized product and/or inventory information is sent to a known address, fax, email, regular mail, or other appropriate known method for reaching the authorized party without any authentication being sent to the manufacturer.

Authorized product information can include product images, product descriptions, product specifications, warranty information, certification information, SKU (stock keeping unit) numbers, manufacturer reference numbers, serial numbers, product option information, pricing information, availability information, and/or new/used information. In 304, authorized product and inventory information is made available for display. In some embodiments, authorized product and inventory information is prepared and posted on a website that can be navigated by a customer. In 306, information is requested regarding desired products. Information requests can be made by clicking on a website, emailing, live chatting, calling on a phone, messaging, faxing, or any other appropriate method of communicating the information request. Information requests can include requests for consultation regarding style or appropriate options or products for a customer as recommended by a consultant and/or professional appropriate to respond to these information requests. In some embodiments, information is designated as authorized by using a brand logo, an authorized logo, an authentication mark or certification, or any other appropriate method of designating that the information is authorized. In some embodiments, the retailer is designated as authorized by web links to authorized sites, web authorization from a manufacturer web sites, by logo, by authorized mark or certification, or by any other appropriate method of designating that the retailer is authorized. In 308, information is sent regarding desired products. Information can be sent by posting on a website, emailing, live chatting, calling on a phone, messaging, faxing, or any other appropriate method of communicating the information. In 310, it is determined if there is any more information requested. If there is more information requested control passes to 306. If there are no more requests, then the process ends.

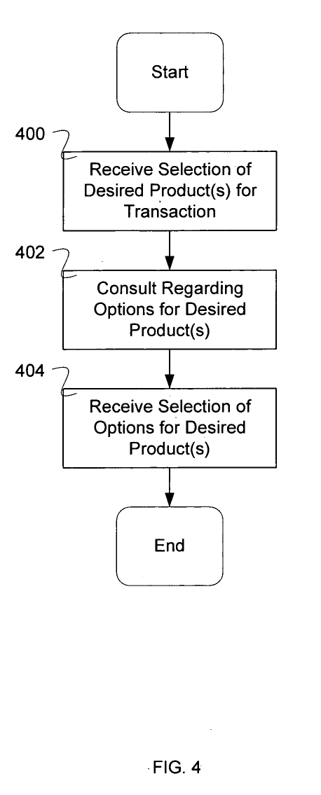

FIG. 4 is a flow diagram illustrating an embodiment of a process for receiving a selection of a desired product. In some embodiments, the process of FIG. 4 is used to implement 202 in FIG. 2. In the example shown, in 400 a selection of one or more desired products is received for a transaction. For example, in the case where the desired product is a watch, the manufacturer of the watch, a selection of the collection and model type of the watch might be received. In 402, options for the desired product(s) are consulted upon. Consultation can include interacting with a style consultant or a professional appropriate for consulting regarding options of a desired product. For example, in the case where the desired product is a watch, options for the watch include case size, case material, bezel type, movement type, engine type, extra features (alarm, date, chronograph, month, moon phase, etc.), dial color, crystal material, and strap type. Or for example, in the case where the desired product is a ring, options for the ring can include ring material, type of precious stones included in the ring, stone quality, stone color, stone clarity, etc. In some embodiments, no consultation is required. In 404, a selection of options for the desired product(s) are received.

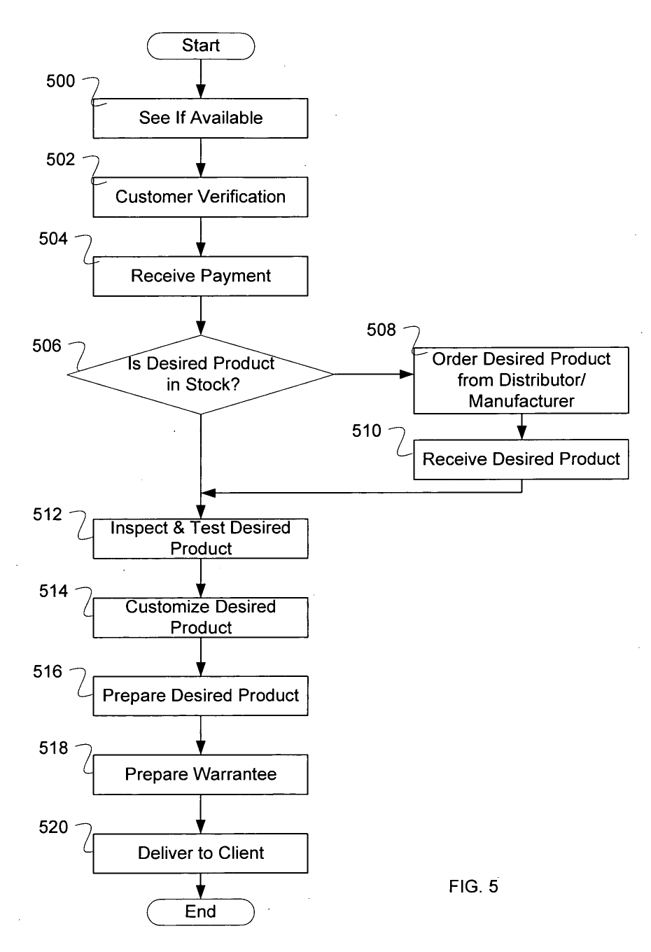

FIG. 5 is a flow diagram illustrating a process for completing a transaction for a desired product. In some embodiments, the process of FIG. 5 is used to implement 204 of FIG. 2. In the example shown, in 500 it is determined if the product is available. The distributor and/or the manufacturer is contacted to see if the desired product with the desired options is available and when the product is available. In 502, the customer is verified. Customer verification can include obtaining drivers license information and/or a copy of the license, credit card information, sales tax form information, use tax information, wire transfer information, shipping and billing information, address, bank information, approval information, and/or signature. In some embodiments, customer signature is a digital signature wherein customer verification is based at least in part on the digital signature. In various embodiments, a digital signature is based on public key cryptographic techniques or is a method for authenticating digital information. In some embodiments, customer signature is an electronic signature wherein the electronic signature is a method for identifying the originator of an electronic message. In 504, payment is received. In some embodiments, the payment is a partial payment with the remainder of the payment due at a later date, before shipping the product, or whenever appropriate for the remainder of the payment should be due. In 506, it is determined if the desired product is in stock. If the desired product is not in stock, then in 508 the desired product is ordered from the distributor or manufacturer. In 510, the desired product is received and control passes to 512. If the desired product is in stock, then control passes to 512.

In 512 of FIG. 5, the desired product is inspected and tested. Inspection can include checking for defects. Testing can include checking water proof rating, accuracy, shock resistance, durability, etc. In 514, the desired product is customized. For example, if the item is a watch, then the customization can be that the watch band is resized to fit the customer. Or for example, if the desired product is a ring, then the ring band is resized to fit the customer's finger. In 516, the desired product is prepared for customer. Preparation can include cleaning, and if the desired product is a watch, setting the watch and winding the watch. In 518, the warranty is prepared. Warranty preparation can include filling out a warranty form, stamping the form with an official manufacturer's seal, or stamping the form with an official retailer's seal. In some embodiments, preparing a warranty comprises preparing a digital warranty. In 520, the desired product is delivered to client. Delivering to the client can include insuring the desired product for shipping, packing the product, shipping the product, or hand delivering the product to the customer.

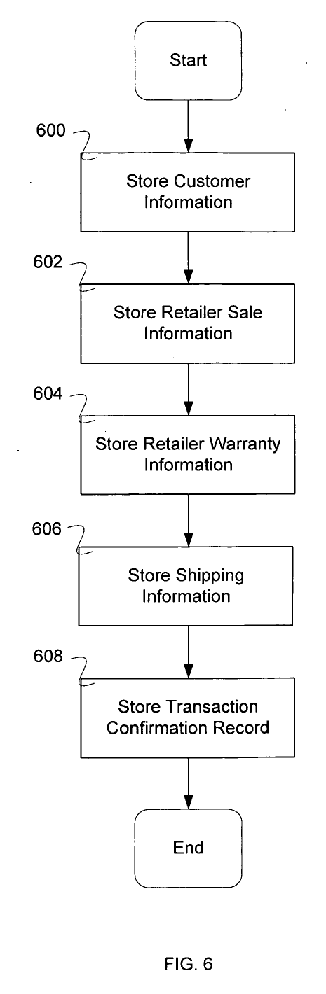

FIG. 6 is a flow diagram illustrating an embodiment of storing transaction information including a transaction confirmation record. In some embodiments, the process in FIG. 6 is used to implement 206 of FIG. 2. In the example shown, in 600 customer information is stored. Customer information can include a customer name, a customer residence address, a payment method, driver's license information, signature record, bank information, credit card information, sales tax form information, use tax information, wire transfer information, shipping address, billing address, approval information. In some embodiments, customer signature is a digital signature wherein customer verification is based at least in part on the digital signature. In various embodiments, a digital signature is based on public key cryptographic techniques or is a method for authenticating digital information. In some embodiments, customer signature is an electronic signature wherein the electronic signature is a method for identifying the originator of an electronic message.

In 602, retailer sale information is stored. Retailer sale information can include sale price amount, sale item manufacturer, sale item SKU number, sale item serial number, sale item options, sale date, sales transaction identifier, sales receipt number, and/or sale item picture. In 604, retailer warranty information is stored. Retailer warranty information can include warranty item (including manufacturer, model, version, options, etc.), warranty serial number, warranty sale retailer information, warranty sale date, warranty sale purchaser, warranty service information (including dates of service, type of service, service performer, etc.), digital warranty, and/or warranty certificate copy, authorized distributors name, address, phone number, duty/customs information such as a confirmation number, entry point, duty paid, or any other relevant duty/customs information. In various embodiments, a manufacturer and/or a customer can access stored digital warranty information in order to check the existence and authenticity of the warranty. In some embodiments, the digital warranty information is protected by tamper resistant technology including encrypting, fingerprinting, or hashing at least a part of the warranty information, or adding a tamper resistant identifier, or any other appropriate method for making the warranty information tamper resistant. In 606, shipping information is stored. Shipping information can include shipping destination address, shipping carrier, shipping cost, shipping date, shipping insurance information, shipping packaging image, shipping tracking number, shipping inspection information, shipping receipt information, and/or shipping receipt signature.

In 608, a transaction confirmation record is stored. In some embodiments, the transaction confirmation record includes any appropriate information from customer information, store sale information, store warranty information, and shipping information. In some embodiments, only a transaction confirmation record is stored where the transaction confirmation record comprises appropriate information regarding the customer, the retailer, the warranty, and the shipping. In various embodiments, the transaction record includes a transaction record identifier, transaction record create time and/or date, trusted outside information (for example, external trusted time and/or date stamp, consistency information (for example, sequential record identifier), additional tamper deterrence and/or authenticity information (for example, digital fingerprints, checksums, hashes, etc.). In some embodiments, the transaction record is stored in a manner that deters tampering. In various embodiments, at least a part of the transaction record (for example, the transaction record identifier, the transaction record date, the entire transaction record, or any other appropriate part of the transaction record) and/or database that contain transaction records is encrypted, is fingerprinted, is created with an application that deters tampering, created on a system that deters tampers, or any other appropriate manner for making a transaction record tamper resistant. In some embodiments, transaction record is stored with consistency information that can be checked to deter tampering (for example, a sequential dated record identifier where the date and the sequence of records can be checked for consistency, or the date the transaction creation date can be checked against the sale date, an external trusted source date, etc.).

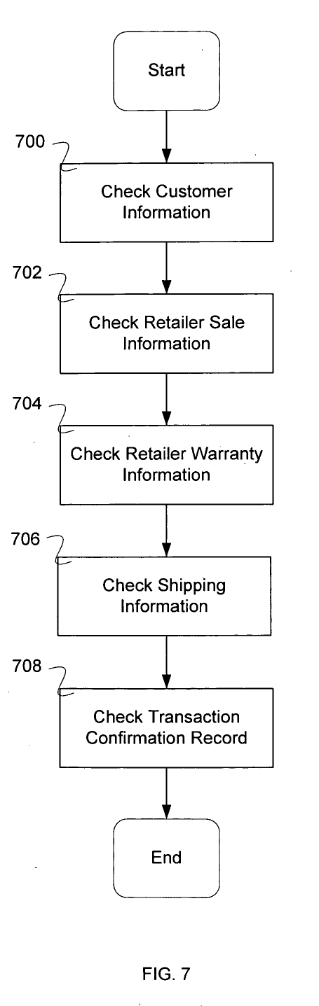

FIG. 7 is a flow diagram illustrating an embodiment of checking transaction information including a transaction confirmation record. In some embodiments, the process in FIG. 7 is used to implement a process that follows 206 of FIG. 2. In the example shown, in 700 customer information is checked. Customer information can include a customer name, a customer residence address, a payment method, driver's license information, signature record, bank information, credit card information, sales tax form information, use tax information, wire transfer information, shipping address, billing address, approval information. In 702, retailer sale information is checked. Retailer sale information can include sale price amount, sale item manufacturer, sale item SKU number, sale item serial number, sale item options, sale date, and/or sale item picture. In 704, retailer warranty information is checked. Retailer warranty information can include warranty item, warranty serial number, warranty sale retailer information, warranty sale date, warranty sale purchaser, and/or warranty certificate copy. In 706, shipping information is checked. Shipping information can include shipping destination address, shipping carrier, shipping cost, shipping date, shipping insurance information, shipping packaging image, shipping tracking number, shipping inspection information, shipping receipt information, and/or shipping receipt signature.

In 708, a transaction confirmation record is checked. In some embodiments, the transaction confirmation record includes any appropriate information from customer information, check sale information, check warranty information, and shipping information. In some embodiments, only a transaction confirmation record is checked where the transaction confirmation record comprises appropriate information regarding the customer, the retailer, the warranty, and the shipping. In various embodiments, the transaction record information that can be checked to detect tampering and/or establish authenticity includes a transaction record identifier, transaction record create time and/or date, trusted outside information (for example, external trusted time and/or date stamp, consistency information (for example, sequential record identifier), additional tamper deterrence and/or authenticity information (for example, digital fingerprints, checksums, hashes, etc.). In some embodiments, the transaction record is checked in a manner that detects tampering. In various embodiments, at least a part of the transaction record and/or database that contain transaction records is checked by decrypting at least a part of the transaction record, checking a fingerprint, checking using the application that deters tampering, checking using a system that deters tampers, or any other appropriate manner for checking that a transaction record has been tampered. In some embodiments, transaction record is checked for consistency by examining consistency information (for example, records can be checked to ensure that sequential dated record identifiers are appropriately sequential, appropriately dated, consistently dated, the date the transaction creation date can be checked against the sale date for consistency, etc.).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of sale and warranty confirmation management including:
displaying product information for a buyer;
receiving a selection of a desired product;
completing a transaction for the desired product; and
storing a transaction confirmation record wherein the transaction confirmation record is auditable in order to confirm that the transaction for the desired product was completed with the buyer.

2. A method as in claim 1, wherein product information is transferred from a manufacturer.

3. A method as in claim 1, wherein product information includes a product photograph.

4. A method as in claim 1, wherein product information includes a product specification.

5. A method as in claim 1, wherein product information includes a product style guide.

6. A method as in claim 1, wherein product information includes a product inventory.

7. A method as in claim 1, wherein product information includes a list of product options.

8. A method as in claim 1, wherein product information includes product pricing.

9. A method as in claim 1, wherein product information includes a product serial number.

10. A method as in claim 1, wherein product information includes a product warranty.

11. A method as in claim 1, wherein product information includes a product authentication certificate.

12. A method as in claim 1, further including transferring at least a portion of the transaction confirmation record to a manufacturer.

13. A method as in claim 1, wherein transaction confirmation record includes customer information.

14. A method as in claim 1, wherein transaction confirmation record includes transaction information.

15. A method as in claim 1, wherein transaction confirmation record includes warranty information.

16. A method as in claim 1, wherein transaction confirmation record includes shipping information.

17. A method as in claim 1, further including checking the transaction confirmation record.

18. A system for sale and warranty confirmation management including:
a processor configured to:
display product information for a buyer;
receive a selection of a desired product;
complete a transaction for the desired product; and
store a transaction confirmation record wherein the transaction confirmation record can be audited in order to confirm that the transaction for the desired product was completed with the buyer; and
a memory coupled to the processor and configured to provide instructions to the processor.

19. A system as in claim 18, wherein product information is transferred from a manufacturer.

20. A system as in claim 18, wherein product information includes a product photograph.

21. A system as in claim 18, further including transferring at least a portion of the transaction confirmation record to a manufacturer.

22. A system as in claim 18, wherein transaction confirmation record includes customer information.

23. A system as in claim 18, wherein transaction confirmation record includes transaction information.

24. A system as in claim 18, wherein transaction confirmation record includes warranty information.

25. A system as in claim 18, further including checking the transaction confirmation record.

26. A computer program product for sale and warranty confirmation management, the computer program product being embodied in a computer readable medium and comprising computer instructions for:
displaying product information for a buyer;
receiving a selection of a desired product;
completing a transaction for the desired product; and
storing a transaction confirmation record wherein the transaction confirmation record can be audited in order to confirm that the transaction for the desired product was completed with the buyer.

27. A computer program product as recited in claim 26, wherein product information is transferred from a manufacturer.

28. A computer program product as recited in claim 26, wherein product information includes a product photograph.

29. A computer program product as recited in claim 26, further including transferring at least a portion of the transaction confirmation record to a manufacturer.

30. A computer program product as recited in claim 26, the computer program product further comprising computer instructions for checking the transaction confirmation record.
